(19) United States
(12) Patent Application Publication
(10) Pub. No.: US 2013/0020993 A1
(43) Pub. Date: Jan. 24, 2013

(54) Multi-Mode Electric Vehicle Charging Station

(71) Applicants: Stephen R. Taddeo, Long Beach, CA (US); David L. Edgar, Los Alamitos, CA (US); Ronald D. Prosser, Huntington Beach, CA (US)

(72) Inventors: Stephen R. Taddeo, Long Beach, CA (US); David L. Edgar, Los Alamitos, CA (US); Ronald D. Prosser, Huntington Beach, CA (US)

(73) Assignee: GREEN CHARGE NETWORKS LLC, Huntington Beach, CA (US)

(21) Appl. No.: 13/552,623

(22) Filed: Jul. 18, 2012

Related U.S. Application Data
(60) Provisional application No. 61/509,010, filed on Jul. 18, 2011.

(51) Int. Cl. H02J 7/00

(52) U.S. Cl. 320/109; 320/107

(57) ABSTRACT

A reduced size and complexity multi-mode electric vehicle charging station is provided which allows a user to select AC and DC powerform output and may provide those outputs to connectors for charging electric vehicles. A voltage source is provided to a DC converter that then outputs to a DC bus or electrical connection. The DC bus may be accessed by DC charging equipment or a DC-AC inverter that is connected to AC charging equipment, thereby providing DC and AC charging ability. In one aspect, the multi-mode electric vehicle charging station is used in a rescue vehicle for charging stranded EVs via multiple charging standards without requiring the rescue vehicle to carry independent charging systems for each charging standard. In another aspect, the charging station is used in a stationary charging station to reduce cost and complexity of using multiple independent charging systems.

### CROSS REFERENCE TO RELATED APPLICATIONS

Priority is claimed to the following related pending U.S. Provisional Patent Application, which is hereby incorporated by reference in its entirety: Ser. No. 61/509,010, filed Jul. 18, 2011.

### BACKGROUND

The present invention relates to the fields of electric vehicle charging systems, electric vehicle charging protocols, electric vehicle charging systems that implement multiple charging standards, and related fields.

In recent years, the popularity and affordability of electric vehicles (EVs) such as battery-powered EVs (BEVs) and hybrid gasoline-electric EVs (HEVs) has grown dramatically. In many cases, the batteries of these vehicles require periodic recharging to keep them in motion. Industry leaders have recognized this need and have identified and implemented a number of charging protocol standards, such as, for example, the Society of Automotive Engineers (SAE) J1772 AC “Level 2” charging standard or the TEPCO® CHAdeMO® DC “quick charge” or “Level 3” charging standard, including corresponding charger connectors and ports. At least one of these standardized ports can be found on most production EVs, but not all chargers are compatible with each standard. Most of the time this poses a minor inconvenience to EV drivers, since they can plan routes around known locations of chargers that are compatible with their EVs, but at times the EV drivers are unable to reach a compatible charger and roadside assistance is needed to tow the EV or to provide some charge to the EV battery to allow it to reach another charging station. Unfortunately, roadside service providers must be able to provide separate sets of charging equipment that comply with multiple charging standards in order to serve a variety of EVs. Equipment costs, operational logistics, and responsiveness to customer requests all suffer due to the randomness inherent in the location and charger compatibilities of the EVs in need of assistance.

### BRIEF SUMMARY

An aspect of the present invention is a multi-mode charging station capable of charging EVs via multiple charging settings and protocols. The multi-mode charging station draws energy from a voltage source that provides a first DC voltage to a DC-DC converter. The DC-DC converter converts the first DC voltage to a second DC voltage that is provided to a DC bus. The DC bus is accessible by a DC interface to connect the system to an EV for DC charging, or the DC bus is accessible by a DC-AC inverter that converts the second DC voltage to an AC voltage that is provided to an AC interface to connect the system to an EV for AC charging. A controller controls the settings of the DC-DC converter and DC-AC inverter to manage which type of charging may take place at any given time.

In another embodiment of the invention the DC bus is connected to DC electric vehicle supply equipment (EVSE) and the DC-AC inverter is connected to an AC EVSE. Each of the EVSEs is connected to an appropriate charging connector that may be linked to a charging port on an EV.

A transceiver may be integrated into the charging equipment to send and receive commands and information for the controller or in association with the EV being charged.

In some embodiments the charging station is installed on a service vehicle, and in other embodiments the charging station is stationary or semi-permanently installed. When installed on a service vehicle, the voltage source is a battery, and may be a low-voltage battery that is connected to a boost converter to charge at high power levels for “level 2” or “level 3” charging modes.

In some embodiments, a charging station is provided having a symmetric conversion stage that converts a first waveform to a second waveform according to symmetric conversion parameters set by a system controller, wherein the second waveform is accessible by a first charging interface compatible with the second waveform, and an asymmetric conversion stage which converts the second waveform to a third waveform when directed by asymmetric conversion parameters, wherein the third waveform is accessible by a second charging interface compatible with the third waveform. In this embodiment the system controller sets the symmetric conversion parameters in such a manner that when a first charging protocol is requested at the first charging interface, the second waveform complies with the first charging protocol, and when a second charging protocol is requested at the second charging interface, the third waveform complies with the second charging protocol.

In some of these embodiments, the symmetric conversion stage converts a first DC waveform to a second DC waveform and the asymmetric conversion stage converts the second DC waveform to an AC waveform. In some embodiments the second DC waveform has a greater voltage magnitude than the first DC waveform. In some embodiments the symmetric conversion stage converts a first AC waveform to a second AC waveform and the asymmetric conversion stage converts the second AC waveform to a DC waveform. In some embodiments the asymmetric conversion parameters are set by the system controller. In some embodiments the symmetric conversion stage and the asymmetric conversion stage are integral parts of a single inverter. In some embodiments the second charging interface is not compatible with the second waveform.

Some embodiments further comprise a transceiver connected to the system controller. In some embodiments the system controller sets the symmetric conversion parameters in response to charging protocol information received via the transceiver. In some of these embodiments the charging protocol information comprises identification of an electric vehicle.

In another embodiment, a multi-mode EV charging system is provided, comprising a voltage source, a DC-DC converter receiving a source voltage from the voltage source, wherein the DC-DC converter is capable of converting the source voltage to a DC bus voltage, a DC charging interface receiving the DC bus voltage, the DC charging interface complying with a DC charging protocol for an EV, a DC-AC inverter receiving the DC bus voltage and capable of converting the DC bus voltage to an AC output voltage, and an AC charging interface receiving the AC output voltage, the AC charging interface complying with an AC charging protocol for an EV.

Some embodiments further comprise an EV receiving charge from the DC charging interface according to the DC charging protocol. In some embodiments, the DC bus voltage has a greater magnitude than the source voltage. In some embodiments the source voltage is a connection to a utility distribution grid. In some embodiments the voltage source is an energy storage and/or power generation system. In some of these embodiments the voltage source is a low-voltage battery and the DC-DC converter is a boost converter. In some embodiments the charging station is configured to be installed on a service vehicle.

In yet another embodiment a method for providing multiple electric vehicle charging protocols from an electric vehicle charging station inverter system is provided. The inverter system in this embodiment comprises a DC-DC converter providing output to a DC-AC inverter and a DC charging interface, the DC-AC inverter providing output to an AC charging interface. The method comprises determining whether charging will be provided from the DC charging interface according to a DC charging protocol or the AC charging interface according to an AC charging protocol, and when a DC charging interface is determined, setting the DC-DC converter to convert a DC signal into a bus signal complying with a DC charging protocol, converting an input DC signal into the bus signal using the DC-DC converter, and providing the bus signal to the DC charging interface in compliance with the DC charging protocol, and when an AC charging interface is determined, setting the DC-DC converter to convert a DC signal into bus signal, setting the DC-AC inverter to convert the bus signal to an AC signal complying with an AC charging protocol, converting an input DC signal into the bus signal using the DC-DC converter, converting the bus signal into the AC signal using the AC-DC inverter, and providing the AC signal to the AC charging interface in compliance with the AC charging protocol. In some embodiments, a charging interface is determined by a connector complying with the DC or AC charging interface being connected to an EV. In some embodiments the DC signal is provided by an energy storage system.

These embodiments may be advantageous because they may reduce costs of charging equipment by using a DC bus that may be already present in a standard DC-AC inverter used for EV charging. A DC interface may be connected to the DC bus to provide DC charging in addition to AC charging using portions of the standard inverter, fully exploiting each portion. The controller provides settings to the DC-DC converter to ensure that the output at the DC bus is compatible with DC charging when DC charging is desired, and provides settings to the converter to ensure that the output at the DC bus is compatible with AC charging via the inverter when AC charging is desired. A user may thus save space and equipment costs (such as acquisition and maintenance costs) when implementing this embodiment of the invention while being able to provide both AC and DC charging protocols to EVs. This may be particularly preferable in roadside assistance scenarios, since size-reduced charging equipment would more easily be installed on a service vehicle, but it may also be advantageous to use in other charging scenarios where resources and space are limited.

Other goals and advantages of the invention will be further appreciated and understood when considered in conjunction with the following description and accompanying drawings, will be obvious from the description, or may be learned by the practice of the invention. While the following description may contain specific details describing particular embodiments of the invention, this should not be construed as limitations to the scope of the invention but rather as an exemplification of preferable embodiments. For each aspect of the invention, many variations are possible as suggested herein that are known to those of ordinary skill in the art. A variety of changes and modifications can be made without departing from the scope of the invention.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings, wherein like reference numerals across the several views refer to identical or equivalent features, of which:

FIG. 1 shows an insertion block diagram of a circuit according to an embodiment of the present invention.

FIG. 2 shows an insertion block diagram of a circuit connected to an EV according to an embodiment of the present invention.

FIG. 3 shows a more detailed circuit diagram of a circuit according to an embodiment of the present invention connected to an EV.

FIG. 4 shows exemplary EV charging equipment being delivered to a stranded EV according to an embodiment of the present invention.

FIG. 5 shows exemplary EV charging equipment in a stationary charging station according to an embodiment of the present invention.

### DETAILED DESCRIPTION

While preferable embodiments of the invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It shall be understood that different aspects of the invention can be appreciated individually, collectively, or in combination with each other.

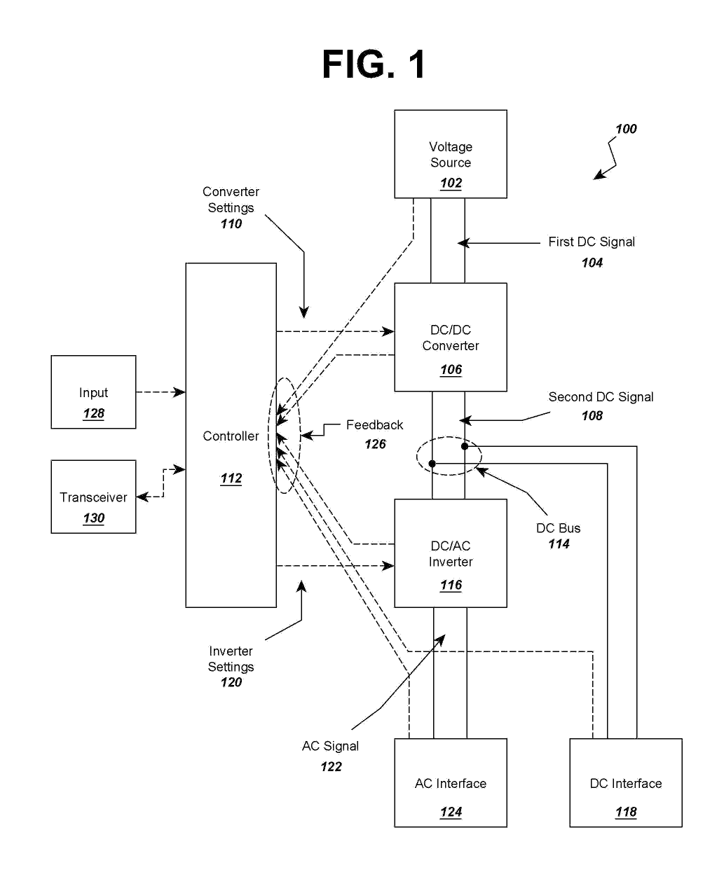

Turning now to the figures in detail, FIG. 1 shows an insertion block diagram of a circuit of an EV charging station 100. A voltage source 102 has a first DC signal 104 that is electrically connected to a DC to DC converter 106. The DC to DC converter 106 converts the first DC signal 104 to a second DC signal 108 according to converter settings 110 provided by a controller 112. The second DC signal 108 is provided to a DC bus 114. The DC bus 114 is electrically connected to a DC-AC inverter 116 and has outputs for a DC interface 118. The DC-AC inverter 116 is controlled by the controller 112 (via inverter settings 120) to output an AC signal 122 to an AC interface 124 when the inverter 116 is activated. The controller 112 is further wired to receive feedback 126 from the converter 106 and the inverter 116 and to receive input 128 and/or to send and receive signals via a transceiver 130.

The EV charging station 100 may include a controller 112 and transceiver 130 to adjust converter settings 110 and inverter settings 120, but the user may adjust the settings of the converter 106 and the inverter 116 directly in some embodiments. The EV charging station 100 may be enclosed in its own housing or may be part of another structure or circuit. Portions of the EV charging station 100 may also be housed in separate enclosures or locations. The charging station 100 may be designed to be mobile by minimizing the size and weight of the voltage source 102, converter 106, and inverter 116 or may be designed to be stationary (or semi-permanent) at a site as well with larger and/or less portable components, if necessary.

In some embodiments the voltage source 102 may include any structure or system capable of storing energy, such as an array of secondary or rechargeable electrochemical batteries, capacitors, fuel cells, supercapacitors, hypercapacitors, superconducting magnetic energy storage, other electrochemical, electrical, or mechanical energy storage systems known in the art, or combinations thereof, and/or a connection to an electrical distribution grid or microgrid that provides a first DC signal 104 to the DC-DC converter 106. When the voltage source 102 is capable of storing energy it may be capable of being charged and discharged repeatedly. Any discussion of any particular type of energy storage system for a voltage source 102 may also be analogously applicable to any other type of energy storage device. The voltage source 102 batteries may have controllable fast charge/discharge capability due to the use of the DC-DC converter 106 and DC-AC inverter 116. Any number of voltage sources 102 may be provided within the EV charging station 100. For example, one, two, three, four, five, six, eight, ten, fifteen, twenty, or more devices may be provided in the system. For example, n voltage sources may be provided, where n is any integer with a value of one or greater. In some embodiments, the voltage sources may be all of the same type (e.g., the same type of battery shape and voltage), while in other embodiments different types of voltage sources may be used in combination (e.g., any of the voltage sources mentioned herein may be used in conjunction with any other of the voltage sources mentioned). The voltage sources may be connected in parallel, series, or in any other combination that produces the voltage and current desired to provide as a first DC signal 104.

A first DC signal 104 may include an electrical signal having a voltage and current. The DC-DC converter 106 converts the first DC signal 104 up or down to the level of the voltage and/or current of the second DC signal 108.

A DC-DC converter 106 may include one or more DC-DC converters connected in series, parallel, or some combination thereof. These converters may be described as “symmetric” since they convert one type of waveform to the same type of waveform, as would an AC-AC converter, as opposed to “asymmetric” converters which convert DC to AC or vice versa. The DC-DC converter 106 (i.e., DC conversion stage) comprises the electronics necessary to convert the first DC signal 104 into the second DC signal 108. The second DC signal 108 may be a high voltage supplied to the DC bus 114 so that the DC interface 118 can be used to charge an EV via DC charging, DC fast charging, quick charging, and the like. For example, the voltage of the second DC signal 108 can be in a range of about 100 to 500 volts to comply with DC charging via a Tokyo Electric Power Company® (TEPCO®) CHAdeMO® connector or other “Level 3” DC-charging standard or other protocol requiring such a high voltage. A higher and lower range of DC voltages may be implemented, such as 0 to 100 volts or 500 or more volts, as required for DC charging. The current of the second DC signal 108 may also be accordingly increased to a proper DC charging level by the DC-DC converter 106.

The second DC signal 108 may also be provided to the DC bus 114 for conversion by the DC-AC inverter 116 into an AC signal 122, so the second DC signal 108 may also be configured by the DC-DC converter 106 to a DC voltage and current needed for the inverter 116 to produce the AC signal 122 required for AC charging at the AC interface 124. The second DC signal 108 may therefore be a voltage that would be suitable for both DC charging via the DC interface 118 and conversion to the AC signal 122 for AC charging, or the second DC signal 108 may be configurable to be at a level of either DC charging or conversion to the AC signal 122 by the user or controller 112. By allowing the second DC signal 108 to be adjusted to DC charging levels and to DC levels suitable for conversion to AC charging levels, a user of the EV charging station 100 may charge EVs at multiple charging protocols without having to provide separate converter equipment or voltage sources for each charging type.

Converter settings 110 may include signals to the DC-DC converter 106 from the controller 112 to alter the second DC signal 108, and inverter settings 120 may include signals to the DC-AC inverter 116 from the controller 112 to alter the AC signal 122 output. The converter and inverter settings 110 and 120 signals may be automated by an algorithm of the controller 112 or may be inputs 128 delivered by a user or remote command software and converted by the controller 112 into a form executed by the DC-DC converter 106 (in the case of converter settings 110) or the DC-AC inverter 116 (in the case of inverter settings 120). In some embodiments, the converter settings 110 are directly input by the user to the DC-DC converter 106.

A controller 112 may include one or more computers or computing devices comprising a processor, memory, and/or data storage device. A controller 112 may include input and output connections, and may be connected directly or indirectly to the DC-DC converter 106, DC-AC inverter 116, or other elements. Input 128 to the controller 112 may include electronic signals, physical forces such as manipulated mechanical switches or magnetic forces, or other instructions such as software stored on a disk or instructions sent from a remote server. A transceiver 130 may be provided to allow the controller 112 to send and receive signals, such as, for example, to allow the controller 112 to send a signal indicating the type of charging performed by the EV charging station 100 or a signal indicating whether it has detected errors in the charging process or electronics. The converter settings 110 and inverter settings 120 may be instructions whether to charge or discharge, the power/current/voltage level to convert, charge, or discharge, the maximum duration of charge or discharge, instructions to cut off charging under predetermined conditions such as if there is a loss of communication with the controller or user, and/or other parameters relevant to the operation of EV charging. It may be advantageous to allow the instructions provided by the controller to depend on feedback 126 provided by the DC-DC converter 106, DC-AC inverter 116, voltage source 102, DC interface 118, AC interface 124, or other elements of the EV charging station 100 or outside elements and intelligently adjust the instructions and settings 110 and 120 provided to the elements of the EV charging station 100. These instructions and settings 110 and 120 may also include default instructions in case communication is lost and feedback 126 is no longer provided. Such default instructions may take the latest feedback into account, which may allow for updated performance even when connections in the circuit are lost.

In some embodiments, a controller 112 may be provided for each converter 106 and inverter 116 or for one or some portion of all converters and inverters in the EV charging station 100, such as, for example, a subgroup of converters or inverters in the station. These controllers may interact with each other or may operate independently to perform the functions described in connection with controller 112.

A DC bus 114 may include electrical ports or terminals on or around the DC-DC converter 106 or DC-AC inverter 116 and corresponding conductive materials connecting the DC-DC converter 106 with the DC-AC inverter 116 and the DC interface 118. Other configurations for a DC bus will be apparent to a person having ordinary skill in the art.

A DC-AC inverter 116 may include single-phase, three-phase, or other multi-phase powerform inverter electronics to convert the second DC signal 108 into an AC signal 122 that enables charging via the AC interface 124 according to a charging protocol. The DC-AC inverter 116 may be comprised of one or more than one inverter or a combination of inverters, commutators, and converters as necessary to change the second DC signal 108 into the AC signal 122. The DC-AC inverter 116 performs its function in accordance with inverter settings 120 sent to it by the controller 112. Inverter settings 120 may include the desired output AC signal 122, information regarding the properties of the second DC signal 108, an enable/disable signal, and other similar information that is relevant to inverter operation. Whether or not a controller 112 is present in the charging station 100, in some embodiments the DC-AC inverter 116 may be adjusted directly by a user.

A DC interface 118 may include connectors or electric vehicle supply equipment (EVSE) that permits the charging station 100 to be linked to an EV or battery of an EV. The DC interface 118 may include converters or signal conditioning circuitry (e.g., DC filters and converters) to adapt the second DC signal 108 for ideal DC charging. Preferably, the DC interface 118 is a connection point without signal conditioning circuitry, a configuration that may be made possible by setting the DC-DC converter 106 to output a second DC signal 108 that matches the characteristics required for DC charging of the stranded/depleted EV's battery. For example, the user may input (e.g., at 128) the name of the manufacturer and model of the EV being charged, and the controller 112 determines that the proper charging power for the DC interface for that vehicle is 400 VDC and 200 amps, so the controller 112 sets the converter settings 110 for the DC-DC converter 106 to produce 400 VDC and 200 amps at the DC bus 114, disables the DC-AC inverter 116, and enables the converter 106 to convert the first DC signal 104. The controller 112 may continue to monitor the second DC signal 108 via feedback signals 126 and adjust the converter settings 110 to sustain the proper 400 VDC output at the DC bus 114 until charging of the EV is completed. In some embodiments, the DC interface 118 may include charging circuitry that is otherwise typically installed within the EV for DC charging, such as, for example, when the DC interface 118 is compliant with the CHAdeMO® charging standard. The DC interface 118 may also include safety switches and indicators to protect users and equipment from harm.

An AC signal 122 may be an electrical signal including a voltage and current that is sent to the AC interface 124 that is sufficient for charging an EV battery from a connection to the AC interface 124. For example, if the AC interface is compatible with the SAE J1772 AC charging standard, the AC powerform is single-phase and approximately 240 volts AC. The properties of the AC signal 122 may be controlled by adjusting the inverter settings 120 or by adjusting the converter settings 110 to change the second DC signal 108 received by the DC-AC inverter 116. Preferably, the controller 112 monitors the AC signal 122 by taking feedback signals 126 from the DC-AC inverter 116 and AC interface 124 and makes necessary adjustments to the converter settings 110 and inverter settings 120 to keep the AC signal 122 consistent. In some embodiments, the AC signal 122 may be changed to a number of different charging protocols so that the charging station 100 may support charging an EV using multiple AC charging standards.

An AC interface 124 may include connectors or EVSE that permits the charging station 100 to be linked to an EV or battery of an EV. The AC interface 124 may include, for example, signal conditioning circuitry (e.g., AC filters and transformers), safety switches, special connectors, and signal indicators to assist the user in charging an EV and to protect users and equipment from harm. In some embodiments the AC interface 124 is merely a socket or connector that is directly linkable to an EV because the AC signal 122 is calibrated and filtered by the inverter 116 and other electronics in the charging station 100 to match a charging protocol needed for charging an EV directly from the AC interface 124.

Feedback 126 may include readings from voltmeters, ammeters, thermometers, and other sensors placed on or in the voltage source 102, DC-DC converter 106, DC-AC inverter 116, DC interface 118, AC interface 124, or any other point in the EV charging station such as the DC bus 114. Feedback 126 may also include signals from controllers connected to these subcomponents of the charging station 100. Feedback 126 is received by the controller 112 and may be used to affect and calculate adjustments to the converter settings 110 and inverter settings 120 in order to ensure the system operates within prescribed operating conditions. For example, if the voltage of the second DC signal 108 exceeds predetermined threshold maximum levels, a voltmeter at the DC bus 114 or on the DC-DC converter 106 sends a signal to the controller 112 and converter settings 110 are updated to bring the second DC signal 108 back to proper levels. If converter settings 110 do not fix the problem, the controller 112 may potentially shut off the DC-DC converter 106 or DC interface 118 to protect the systems or a connected EV from damage.

Controller input 128 may include instructions or data related to the charging event, and may be input by a user at the site (e.g., pressing a button or entering a keystroke on a keypad), a remote computer associated with the charging equipment, or may be automated as a form of interaction with the EV. Automated input 128 may include preprogrammed instructions for the controller 112 of the charging station, such as, for example, a triggering function in the controller 112 wherein the act of connecting an AC connector plug into the AC interface 124 or into an EV is a form of input 128 by which the controller 112 is triggered to allow charging to take place via the AC interface. The subject matter of the controller input 128 may include data, such as, for example, the target second DC signal 108 or AC signal 122, or may include information such as the stranded EV's manufacturer and model number, so that the controller 112 may then arrange the charging station's electronic parameters for charging that type of vehicle. For instance, if a specific EV model does not support a DC charging connection, the controller 112 would disable the DC interface 118 and set the DC-DC converter 106 and DC-AC inverter 116 to appropriate levels to charge via the AC interface 124 alone. In another example, if the EV only supports DC charging, the controller 112 may disable the AC interface 124 and DC-AC inverter 116 to prevent energy losses and risk to the user and charging equipment.

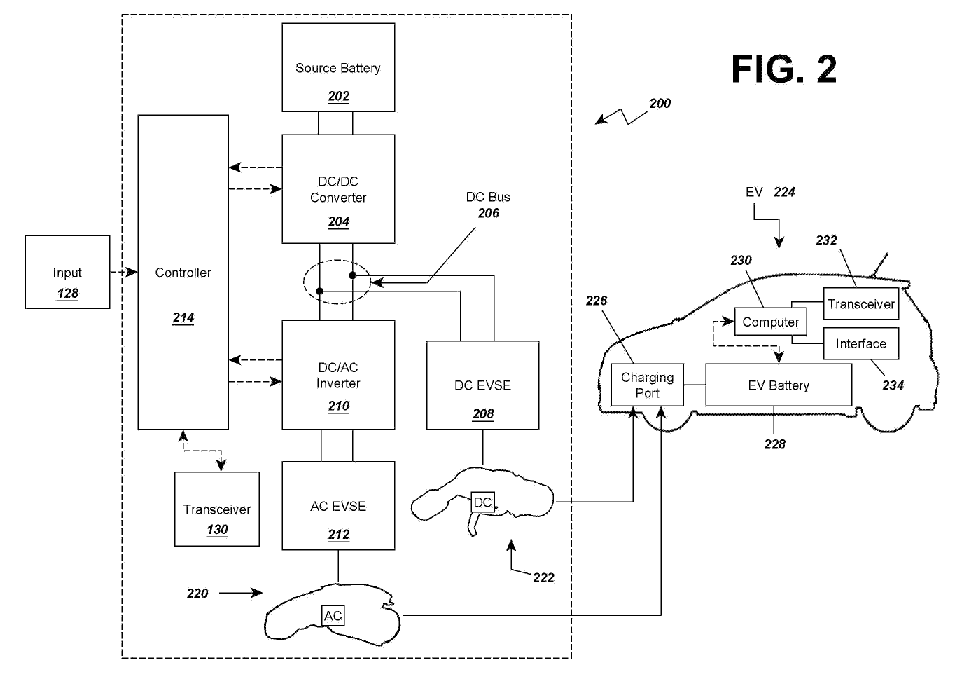

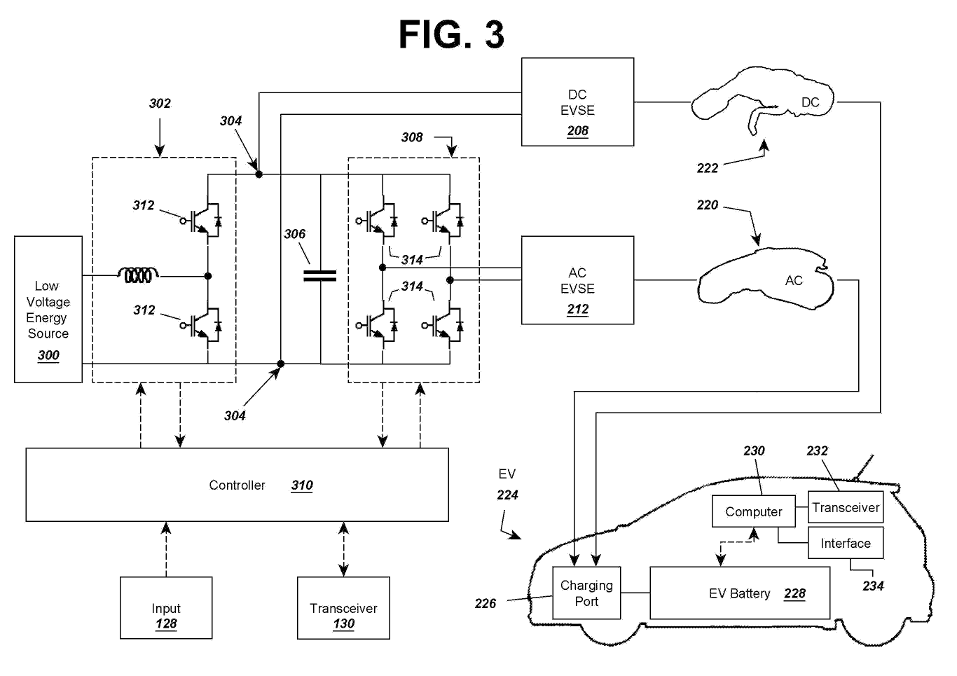

A transceiver 130 may include an analog and/or digital transceiver such as a RFID, radio, wifi, cellular, or wireless ethernet antenna and similar bidirectional structures. The transceiver 130 may be included as part of the charging station 100 that allows the controller 112 to interact with external devices, such as, for example, by receiving commands from a radio frequency transmitter to enable charging or by sending charging information to an external device or remote server. In some embodiments a compatible/matching transceiver may be placed on a charging connector attached to the EV or on EVs for which the charging station 100 is compatible (see, e.g., FIGS. 2 and 3 at transceiver 232) to allow the controller to monitor the charge transferred to the EV and determine whether there are any faults in the charging system or the EV.

FIG. 2 shows an insertion block diagram of a circuit connected to an EV according to an embodiment of the present invention. A charging station 200 comprising a source battery 202 connected to a DC-DC converter 204, which converts the voltage of the source battery 202 to provide a high voltage to a DC bus 206 which in turn provides the high voltage to DC electric vehicle supply equipment (EVSE) 208, a DC-AC inverter 210 receiving the high voltage of the DC bus 206 connected to AC EVSE 212. The converter 204 and inverter 210 of the station send and receive signals to and from a controller 214 which may receive input 128 or send and receive signals from a transceiver 130. The AC EVSE 212 and DC EVSE 208 are connected to an AC connector 220 and a DC connector 222, respectively, that provide charge to an EV 224 when connected to a corresponding charging port 226, thereby energizing an EV battery 228. The EV 224 may also have a computer 230 linked to a transceiver 130 and/or interface 234.

A charging station 200 may include elements from the charging station 100 in FIG. 1. Charging station 200 is specially adapted for mobile operations since the source battery 202 allows the charging station 200 to be used in areas where a grid connection or other permanent and immobile energy source is not available.

A source battery 202 may include one or more electrochemical batteries installed in the charging station 200 or external to and connected to the charging station 200. In some embodiments the source battery 202 is a modular battery that may be installed and disconnected quickly for transfer to and from a service vehicle, as the modular batteries seen in U.S. Provisional Patent Application No. 61/489,849, which is hereby incorporated by reference in its entirety. The source battery 202 may have a low voltage, such as a bank of 12-volt batteries, that is converted to 400 volts or more by the DC-DC converter 204 for DC charging and for conversion by the DC-AC inverter 210 for AC charging. Use of a source battery instead of a more generic voltage source may be advantageous because batteries have increased portability, which is useful in a mobile charging system since it does not need to be constantly tethered to a distribution grid or require large reserves of fuel for a generator.

In one embodiment the DC-DC converter 204 and DC-AC inverter 210 may be integral parts of a standard inverter, where the DC-DC converter 204 is used to boost the voltage of the source battery 202 to a high level that is then typically sent to the DC-AC inverter 210 that may include, for example, a commutator for producing an AC output. In this embodiment, however, the DC bus 206 is accessed by the DC EVSE 208. As a result, the controller 214 may direct the DC-DC converter 204 to produce a voltage to the DC bus 206 that is sufficient for DC charging via the DC EVSE 208 or that is sufficient for AC charging via the DC-AC inverter 210 and AC EVSE 212.

A DC EVSE 208 and AC EVSE 212 may include connectors, converters, and safety equipment that allow DC and AC charging from the voltage at the DC bus 206 to the EV 224 through the DC connector 222 and the AC connector 220, respectively.

An AC connector 220 may include an SAE J1772 connector or other AC-charging-compatible connector, and the DC connector 222 may include a TEPCO® CHAdeMO® connector or other DC-charging-compatible connector. For example, the AC connector 220 may be capable of level 2 AC charging and level 2 AC fast charging, and the DC connector 222 may be capable of level 3 DC charging. The connectors 220 and 222 may be designed to comply with industry standards or may be adapted to fit with customized, unpopular, or unconventional ports without departing from the spirit of the invention, but, preferably, the connectors 220 and 222 are compatible with industry standards so that they do not have to be switched out frequently and may be used to charge vehicles from a large assortment of manufacturers and models.

An EV 224 may include any type of electrically-driven vehicle where electrical energy provides motive power, including micro hybrid EVs (HEVs), mild HEVs, full HEVs, plug-in hybrid EVs (PHEVs), battery EVs (BEVs), fuel cell EVs (FCEVs). The EV 224 has at least one charging port 226 to which an AC connector 220 or DC connector 222 may connect to supply power to the EV battery 228.

A charging port 226 may include, for example, a female CHAdeMO® port for DC charging, a female SAE J1772 port for AC charging, another standardized charging port, or a customized charging port. An EV may bear multiple compatible charging ports, in which case the user may choose whether to connect one or more of the DC and AC connectors 220 and 222 for charging the EV.

An EV battery 228 may include a single battery, but it may include an array of batteries, battery modules, removable batteries, a fuel cell, capacitor or plurality of capacitors or supercapacitors, or other energy storage device that provides energy that is used to move the EV 224. When the EV battery 228 is energized it provides energy to the vehicle to move. In the case of hybrid electric vehicles, a gasoline-based engine may also provide power to move the vehicle, so the charging station 200 would therefore be preferable in situations where the onboard EV battery 228 in the hybrid is depleted and the fuel for the engine is also empty, so the source battery 202 may provide energy to the EV battery 228 to at least enable the EV 224 to reach a gas station or other EV charging station, if not to provide a more substantial charge.

A computer 230 in the EV 224 is an element that may include an onboard electronics control unit (ECU), battery management system, processor, vehicle controller, or comparable processing and executing unit. The computer 230 may be used to monitor the state of charge of the EV battery 228, for example, and to relate that information to the EV operator through an attached interface 234. The computer 230 may also send information about the EV 224 or other EV systems to a transceiver 130, antenna, or other communication device that can relay that information to the transceiver 130 of a charging station 200 or other monitoring computer or server. In one embodiment, this is advantageous because the controller 214 may be instructed to only provide a certain amount of kilowatts to the EV 224 or is instructed to turn off charging via the connectors 220 and 222 when the temperature of the EV battery 228 exceeds safe limits. In another embodiment the EV 224 may communicate its location and charging requirements to the controller 214 and the controller may set the converter 204 and inverter 210 for optimal compatibility with the EV 224 systems. Interaction between the charging station 200 and the EV 224 may improve safety, optimize the efficiency of the systems, and assist the user in completing successful charging operations.

An interface 234 may include a screen, display, light, computer, audio alert, combinations thereof, or other objects for interaction with the EV user that may be apparent to a person with ordinary skill in the art.

FIG. 3 shows a more detailed circuit diagram of a circuit according to an embodiment of the present invention connected to an EV. A low voltage energy source 300 provides a first voltage and current to a DC-DC boost converter 302 that up-converts the first voltage and current to a second voltage and current provided to a DC bus 304. A DC EVSE 208 is connected to the bus 304, and the DC EVSE 208 provides power to a DC connector 222. A stabilizing capacitor 306 stabilizes the second voltage and current as it is provided to a DC-AC inverter 308 and then an AC EVSE 212 and AC connector 220. A system controller 310 controls transistors in circuit elements 312 and 314 of the converter 302 and the inverter 308 according to inputs 128 and may communicate with a transceiver 130.

A low voltage energy source 300 may include batteries or other energy storage, and it may also include a more lasting energy supply such as a connection to a distribution grid or renewable energy generation source that is configured for on-demand energy supply to the boost converter 302. A “low” voltage in this embodiment means it has a lower voltage than that required by the DC EVSE 208 for charging and less than the voltage required by the inverter 308 to provide a charging AC signal to the AC EVSE 212.

A DC-DC boost converter 302 may include other topologies than the one depicted here, such as DC-DC converters described above in connection with FIGS. 1 and 2, and in this embodiment those topologies include boost converters that increase the voltage and current of the low voltage energy storage 300 to a charging voltage at the DC bus 304.

A DC-AC inverter 308 may include diodes and transistors in circuit elements 314 and may produce single-phase or multi-phase AC to the AC EVSE 212, depending on whether the AC EVSE 212 used requires single or multi-phase input. In the embodiment of FIG. 3, single-phase AC is produced by the inverter and sent to the AC EVSE 212.

Circuit elements 312 and 314 may include diodes and transistors configured to pass current when directed by the controller 310. The operation and design of these circuit elements 312 and 314 will be known to those having skill in the art of boost converters and inverters. For example, the rating of these circuit elements 312 and 314 will depend on the voltage and current desired at the DC bus 304 for DC charging and the voltage and current required at the AC EVSE 212 for AC charging.

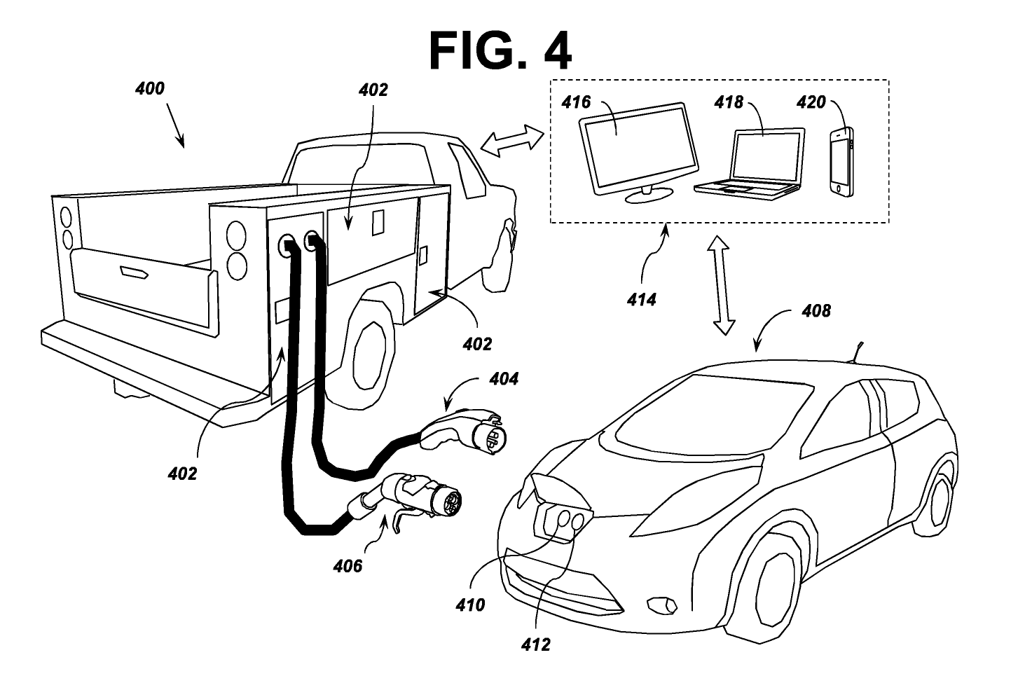

FIG. 4 shows exemplary EV charging equipment being delivered to a stranded EV according to an embodiment of the present invention. A roadside assistance vehicle 400 stores charging station components in storage compartments 402 of the vehicle 400 and provides an AC connector 404 and a DC connector 406 to a stranded EV 408. The stranded EV 408 bears an AC charging port 410 and/or a DC charging port 412. Charging equipment is controlled and/or monitored by a user that inputs commands through interaction devices 414 such as a computer 416 with a display, a notebook computer 418, or other mobile device 420 such as a tablet computer or smartphone.

A roadside assistance vehicle 400 is preferably a truck, car, van, bus, or other wheeled vehicle, but may also include motorcycles, watercraft, aircraft, spacecraft, or other vehicles capable of transporting a charging system to an EV 408. The shape and size of the assistance vehicle 400 is relevant in determining whether the vehicle 400 is capable of moving the charging station to the site of the EV 408.

Charging station components in storage compartments 402 may include source batteries, capacitors, fuel cells, or other energy storage, solar or other PV panels, windmills, generators, and other energy generation devices, aDC-DC converter, DC-AC inverter, and AC and DC interfaces or EVSE. The storage compartments 402 may also beneficially house the charging cables and connectors for attaching the charging station components to the charging ports 410 and 412 of the EV 408.

A stranded EV 408 may include any EV previously discussed, and may include those compatible with the AC or DC connectors 404 and 406 of the charging station transported by the rescue vehicle 400.

An AC or DC charging port 410 or 412 may include a standardized port for charging, such as the SAE J1772 port or the TEPCO® CHAdeMO® port, or may be a different shape. Each EV 408 has different charging capabilities and compatible voltages, including different numbers of charging ports and different locations for the charging ports, and the spirit of the invention embraces all of these EVs as they are compatible with the various charging connectors capable of integration with a charging station of the present invention.

Interaction devices 414 may include computers 418, screens 416, mobile devices 420, and similar input or output devices. In some embodiments, interaction devices are integrated into the charging system of the rescue vehicle 400 such as the devices described in U.S. Provisional Patent Application 61/493,970, which is hereby incorporated by reference in its entirety. The interaction devices 414 may be removable from the charging system or merely independent clients reading information from the controller of the charging system in the rescue vehicle 400. These configurations allow the user to have multiple means to access charging information about the rescue vehicle 400 and EV 408 and may also allow the user to input commands to the charging station if necessary.

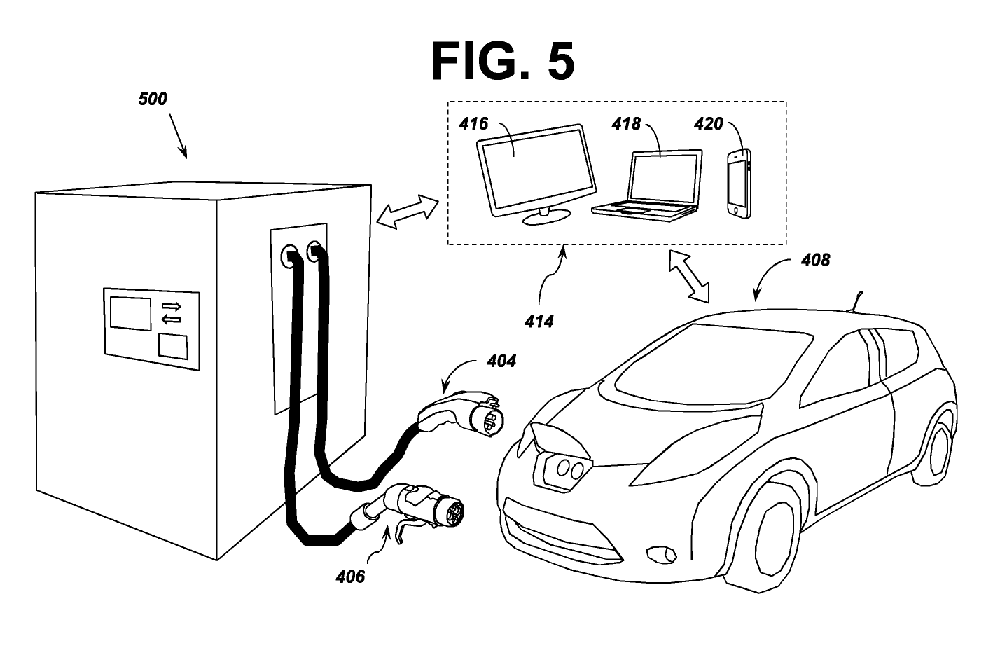

FIG. 5 is a perspective view of an EV 408 at a stationary charging station 500. A charging station of the present invention may be installed at a stationary location, providing both AC and DC charging to EVs from a single point. This design may be useful in comparison to having multiple charging stations providing multiple charging standards due to reduced size, complexity, difficulty to repair, and component costs. In this embodiment, more EVs are supported at a single station by using the same DC converter for AC and DC charging.

Some methods and systems of the embodiments of the invention disclosed herein may also be embodied as a computer-readable medium containing instructions to complete those methods or implement those systems. The term “computer-readable medium” as used herein includes not only a single physical medium or single type of medium, but also a combination of one or more tangible physical media and/or types of media. Examples of a computer-readable medium include, but are not limited to, one or more memory chips, hard drives, optical discs (such as CDs or DVDs), magnetic discs, and magnetic tape drives. A computer-readable medium may be considered part of a larger device or it may be itself removable from the device. For example, a commonly-used computer-readable medium is a universal serial bus (USB) memory stick that interfaces with a USB port of a device. A computer-readable medium may store computer-readable instructions (e.g. software) and/or computer-readable data (i.e., information that may or may not be executable). In the present example, a computer-readable medium (such as memory) may be included to store instructions for the charging system to control the output of converters and inverters or perform other actions and processes disclosed herein.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

In addition, it should be understood that the figures described above, which highlight the functionality and advantages of the present invention, are presented for example purposes only and not for limitation. The exemplary architecture of the present invention is sufficiently flexible and configurable, such that it may be utilized in ways other than that shown in the figures. It will be apparent to one of skill in the art how alternative functional, logical or physical partitioning, and configurations can be implemented to implement the desired features of the present invention. Also, a multitude of different constituent module or step names other than those depicted herein can be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Although the invention is described above in multiple various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the invention, whether or not such embodiments are described and whether or not such features are presented as being a part of a described embodiment. Thus, the breadth and scope of the present invention should not be limited by any of the above-described exemplary embodiments. The invention is also defined in the following claims.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “typical,” “conventional,” “traditional,” “normal,” “standard,” “known” and terms of similar meaning should not be construed as limiting the time described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

A group of items linked with the conjunction “and” should not be read as requiring that each and every one of those items be present in the grouping, but rather should be read as “and/or” unless expressly stated otherwise or context dictates otherwise. Similarly, a group of items linked with the conjunction “or” should not be read as requiring mutual exclusivity among that group, but rather should also be read as “and/or” unless expressly stated or context dictates otherwise. Furthermore, although items, elements or component of the invention may be described or claimed in the singular, the plural is contemplated to be within the scope thereof unless limitation to the singular is explicitly stated. The presence of broadening words and phrases such as “one or more,” “at least,” “but not limited to” or other like phrases in some instances shall not be read to mean that the narrower case is intended or required in instances where such broadening phrases may be absent.

Additionally, the various embodiments set forth herein are described in terms of exemplary block diagrams and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

Further, the purpose of the Abstract is to enable the U.S. Patent and Trademark Office and the public generally, and especially the scientists, engineers, and practitioners in the art who are not familiar with patent or legal terms or phraseology to determine quickly from a cursory inspection the nature and essence of the technical disclosure of the application. The Abstract is not intended to be limiting as to the scope of the present invention in any way.

What is claimed is:

1. A charging station, comprising:
a symmetric conversion stage, the symmetric conversion stage converting a first waveform to a second waveform according to symmetric conversion parameters set by a system controller, wherein the second waveform is accessible by a first charging interface compatible with the second waveform; and
an asymmetric conversion stage, the asymmetric conversion stage converting the second waveform to a third waveform according to asymmetric conversion parameters, wherein the third waveform is accessible by a second charging interface compatible with the third waveform,
wherein the system controller sets the symmetric conversion parameters in such a manner that:
when a first charging protocol is requested at the first charging interface, the second waveform complies with the first charging protocol, and
when a second charging protocol is requested at the second charging interface, the third waveform complies with the second charging protocol.

2. The charging station of claim 1, wherein the symmetric conversion stage converts a first DC waveform to a second DC waveform and the asymmetric conversion stage converts the second DC waveform to an AC waveform.

3. The charging station of claim 2, wherein the second DC waveform has a greater voltage magnitude than the first DC waveform.

4. The charging station of claim 1, wherein the symmetric conversion stage converts a first AC waveform to a second AC waveform and the asymmetric conversion stage converts the second AC waveform to a DC waveform.

5. The charging station of claim 1, wherein the asymmetric conversion parameters are set by the system controller.

6. The charging station of claim 1, wherein the symmetric conversion stage and the asymmetric conversion stage are integral parts of a single inverter.

7. The charging station of claim 1, wherein the second charging interface is not compatible with the second waveform.

8. The charging station of claim 1, further comprising a transceiver connected to the system controller.

9. The charging station of claim 8, wherein the system controller sets the symmetric conversion parameters in response to charging protocol information received via the transceiver.

10. The charging station of claim 9, wherein the charging protocol information comprises identification of an electric vehicle.

11. A multi-mode electric vehicle (EV) charging system, comprising:
a voltage source;
a DC-DC converter receiving a source voltage from the voltage source, the DC-DC converter capable of converting the source voltage to a DC bus voltage;
a DC charging interface receiving the DC bus voltage, the DC charging interface complying with a DC charging protocol for an EV;
a DC-AC inverter receiving the DC bus voltage and capable of converting the DC bus voltage to an AC output voltage; and
an AC charging interface receiving the AC output voltage, the AC charging interface complying with an AC charging protocol for an EV.

12. The system of claim 11, further comprising:
an EV receiving charge from the DC charging interface according to the DC charging protocol.

13. The system of claim 11, wherein the DC bus voltage has a greater magnitude than the source voltage.

14. The system of claim 11, wherein the voltage source is a connection to a utility distribution grid.

15. The system of claim 11, wherein the voltage source is an energy storage and/or power generation system.

16. The charging station of claim 15, wherein the voltage source is a low-voltage battery and wherein the DC-DC converter is a boost converter.

17. The charging station of claim 16, wherein the charging station is configured to be installed on a service vehicle.

18. A method for providing multiple electric vehicle charging protocols from an electric vehicle charging station inverter system, the inverter system comprising a DC-DC converter providing output to a DC-AC inverter and a DC charging interface, the DC-AC inverter providing output to an AC charging interface, the method comprising:
determining whether charging will be provided from the DC charging interface according to a DC charging protocol or the AC charging interface according to an AC charging protocol; and
when a DC charging interface is determined,
setting the DC-DC converter to convert a DC signal into a bus signal complying with a DC charging protocol,
converting an input DC signal into the bus signal using the DC-DC converter, and
providing the bus signal to the DC charging interface in compliance with the DC charging protocol; and
when an AC charging interface is determined,
setting the DC-DC converter to convert a DC signal into a bus signal,
setting the DC-AC inverter to convert the bus signal to an AC signal complying with an AC charging protocol,
converting an input DC signal into the bus signal using the DC-DC converter,
converting the bus signal into the AC signal using the AC-DC inverter, and
providing the AC signal to the AC charging interface in compliance with the AC charging protocol.

19. The method of claim 18, wherein a charging interface is determined by a connector complying with the DC or AC charging interface being connected to an EV.

20. The method of claim 18, wherein the DC signal is provided by an energy storage system.
